(19) United States
(12) Patent Application Publication
(10) Pub. No.: US 2022/0181650 A1
(43) Pub. Date: Jun. 9, 2022

(54) FUEL CELL ASSEMBLY, FUEL CELL SYSTEM, AND FUEL CELL VEHICLE

(71) Applicant: AUDI AG, Ingolstadt (DE)

(72) Inventor: Nico RIEDE, Stuttgart (DE)

(21) Appl. No.: 17/437,329

(22) PCT Filed: Jan. 30, 2020
(86) PCT No.: PCT/EP2020/052214

§ 371 Date: Sep. 8, 2021

(30) Foreign Application Priority Data
Mar. 11, 2019 (DE) 10 2019 203 249.4

(51) Int. Cl. H01M 8/0273; H01M 8/1004

(52) U.S. Cl. CPC H01M 8/0273; H01M 2250/20; H01M 8/1004

(57) ABSTRACT

A fuel cell assembly is provided comprising a membrane electrode assembly that includes a membrane and a first electrode, which is arranged on a first side of the membrane and to which a first gas diffusion layer is assigned. The fuel cell assembly further includes a frame and an adhesive layer directly bonding the membrane electrode assembly to the frame at least in certain areas at an edge area of the membrane electrode assembly. The adhesive layer penetrates the first electrode, and the membrane is directly bonded to the frame as a result of this penetration. A fuel cell system and a fuel cell vehicle comprising such a fuel cell assembly are also provided.

### BACKGROUND

### Technical Field

Embodiments of the invention relate to a fuel cell assembly with a membrane electrode assembly which comprises a membrane and a first electrode, which is arranged on a first side of the membrane and to which a first gas diffusion layer is assigned, as well as having a frame, which may be arranged between the first electrode and the first gas diffusion layer, wherein an adhesive layer directly bonding the membrane electrode assembly to the frame is present at least in certain areas at an edge area of the membrane electrode assembly. Embodiments of the invention also relate to a fuel cell system and a fuel cell vehicle having one or more such fuel cell assemblies.

### Description of the Related Art

A fuel cell assembly can be found in WO 2018/217 586 A1, in which an adhesive layer bonds the bipolar plate to the electrode of a membrane electrode assembly. Fuel cell assemblies that deal with the fixation and sealing of the membrane electrode assembly are described in WO 2010/080 450 A1 and US 2014/0 004 442 A1.

### BRIEF SUMMARY

Some embodiments described herein include an improved fuel cell assembly. Some embodiments described herein include an improved fuel cell system and an improved fuel cell vehicle.

A fuel cell assembly may include an adhesive layer that partially or completely penetrates the first electrode and a membrane that is bonded directly to the frame as a result of this penetration.

This ensures, on the one hand, that the electrode is mechanically bonded to the frame in a more stable manner, since the adhesive layer partially, or completely, penetrates the electrode. On the other hand, however, the penetration of the electrode by the material of the adhesive layer additionally ensures a secure fixation of the membrane to the frame, which contributes to an increased stabilization of the fuel cell assembly. Both also lead to an even better fixation of the electrode to the membrane.

The material of the adhesive layer or adhesive may be formed of a polymer. This results in suitable contact between the membrane and the adhesive layer, since there is then a bond of a polymer with a—possibly further—polymer, which is accompanied by an enhanced adhesive effect. If the frame is likewise also formed of a polymer, this too results in suitable contact between the adhesive layer and the frame. Here, too, there is then a bond of a polymer with a—possibly further—polymer, which is accompanied by an enhanced adhesive effect.

Exactly one frame is, in particular, arranged between the first electrode and the first gas diffusion layer, wherein the adhesive layer at least partially laterally encloses the membrane electrode assembly in an edge area. The exactly one frame reduces the material and layers required for the fuel cell assembly, thus simplifying manufacture. At the same time, the adhesive layer enables stable bonding of the membrane of the membrane electrode assembly to the frame, and the amount of material is also reduced by the fact that the material is only arranged in an edge area of the membrane electrode assembly.

The edge area of the membrane electrode assembly is understood to be an area surrounding the outer circumference side of the membrane electrode assembly, that penetrates at least the first electrode, and extends parallel to the stacking direction and partially orthogonal to the stacking direction. In this, the extension of the edge area orthogonal to the stacking direction corresponds in each case to less than 30 percent, less than 20 percent, less than 10 percent, or less than 5 percent of the total lateral extension of the membrane electrode assembly.

The cross-section of the adhesive layer may be U-shaped or C-shaped. As a result, the adhesive layer serves both as an additional lateral protective layer and as insulation and/or sealing of the membrane electrode assembly. In an alternative embodiment, the cross-section of the adhesive layer can also be L-shaped.

In particular, the membrane electrode assembly may comprise a second electrode that is arranged on a second side opposite the first side, wherein the second electrode may be assigned to a second gas diffusion layer. In this further embodiment, the adhesive layer may also be configured to penetrate the second electrode and thereby directly contact the membrane of the membrane electrode assembly.

The penetration of the electrodes with the adhesive layer material can be realized by the first electrode having a porosity that has been selected such that the adhesive layer partially, or completely, penetrates the first electrode to bond the frame to the membrane. The porosity/surface energy (or in general: the condition) of the electrode and the flow behavior (viscosity, etc.) of the adhesive are matched to each other.

Alternatively, or in complementary manner, the adhesive layer can also have a viscosity selected such that it partially, or completely, penetrates the first electrode to bond the frame to the membrane. Here, too, there is a suitable matching of individual components to one another, which leads to the desired adhesive bond. In this manner, even in the case of limited porosity of the electrodes, it is possible to achieve direct contacting of the adhesive layer with the polymer electrolyte membrane.

In addition, or alternatively, the adhesive layer can have a surface energy and/or a surface tension with respect to the electrode material which is selected in such a way that the first and/or the second electrode are partially, or completely, penetrated, in order to, in particular, bond the frame to the membrane.

To simplify the assembly of the fuel cell assembly, the adhesive layer enclosing the membrane may have a first adhesive layer section bonding the membrane of the membrane electrode assembly to the frame at the edge area and a second adhesive layer section bonding the membrane of the membrane electrode assembly to the second gas diffusion layer at the edge area.

To further reduce the manufacturing complexity, the membrane and the electrodes may be formed with an identical surface area in lateral extension. On the basis of the selection of suitable standard sizes, set-up times for conversion of punching equipment or preparation of hot presses can be reduced.

The frame may have a recess with a flow cross section, the surface area of which is smaller than the lateral surface area. This improves the flow behavior of the reactants of the fuel cell.

The first gas diffusion layer may have a first microporous layer on its side facing the first electrode and/or the second gas diffusion layer may have a second microporous layer on its side facing the second electrode. The microporous layers serve to improve the transport of a cathode or a fuel and increases the performance of the fuel cell inasmuch as the water content of the membrane electrode assembly is increased. The microporous layers may thereby be an integral part of the respective gas diffusion layer. They can, however, also be present as a separate, distinct component.

The possibility furthermore exists that a first sealing layer, which seals the first gas diffusion layer on the circumference side, is assigned to the frame on a first frame side and for a second sealing layer, which seals the second gas diffusion layer and the membrane on the circumference side, is assigned to the frame on a second frame side opposite the first frame side. In this, the sealing layers may be formed as compressible sealing lips or sealing lines.

In order to improve the circumferential sealing, multiple, in particular double or triple, sealing lips are each laterally provided. The sealing lips of the first sealing layer may have a larger diameter than the sealing lips of the second sealing layer. This enables the gas diffusion layers and the membrane electrode assembly to be liquid-tight and/or gas-tight or alternatively fluid-tight in the lateral direction.

The fuel cell assembly described herein may be used in a fuel cell system as described herein. The features described for the fuel cell assembly also apply to the fuel cell system, which is characterized by increased safety and stability.

The features described for the fuel cell assembly thereby also apply to the fuel cell vehicle described herein. The fuel cell vehicle is characterized by a greater range, since diffusion losses of reactants, in particular of fuel, occur less frequently than before when the fuel cell assembly described herein is used.

The features and combinations of features mentioned above in the description, as well as the features and combinations of features mentioned below in the description of the FIGURE and/or only shown in the figures, can be used not only in the combination indicated in each case, but also in other combinations or on their own. Thus, embodiments are also to be considered as encompassed and disclosed which are not explicitly shown in the FIGURES or elucidated upon, but which arise from the elucidated embodiments and are producible by separate combinations of features.

### BRIEF DESCRIPTION OF THE SEVERAL VIEWS OF THE DRAWINGS

Further advantages, features, and details will be apparent from the claims, from the following description of embodiments, and from the drawing.

FIG. 1 shows a cross-sectional view of a fuel cell assembly.

### DETAILED DESCRIPTION

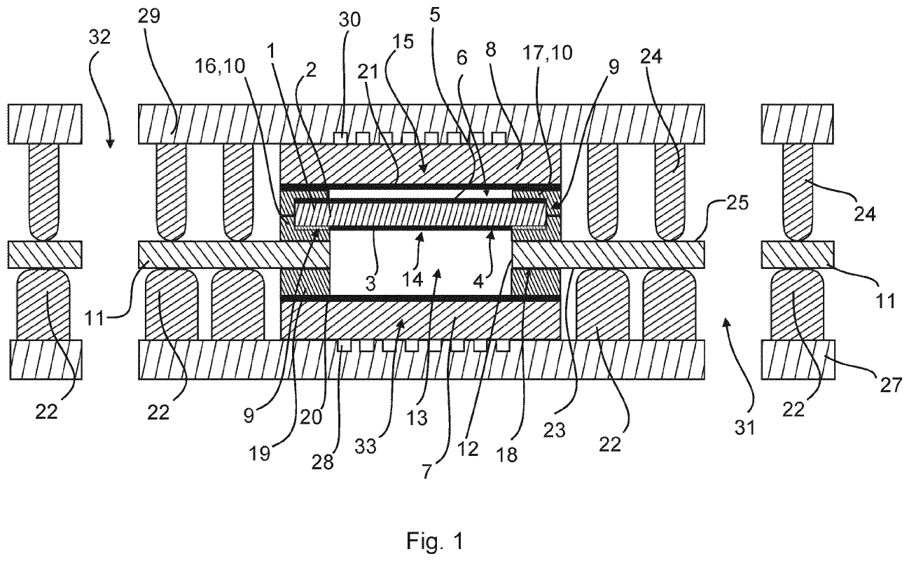

FIG. 1 shows a fuel cell assembly with a membrane electrode arrangement 1, which comprises a semipermeable membrane 2 with a first electrode 3 on its first side 4 and with a second electrode 5 on its second side 6 that is opposite the first side 4. In this, the first electrode 3 may be formed as an anode and the second electrode 5 may be formed as a cathode. There is, however, also the possibility that the first electrode 3 forms the cathode and the second electrode 5 forms the anode of the membrane electrode assembly 1. The membrane 2 may be coated on the first side 4 and on the second side 6 with a catalyst layer made of noble metals or mixtures comprising noble metals such as platinum, palladium, ruthenium or the like, which serve as reaction accelerators in the reaction of the fuel cell. The respective catalyst layer is thereby an integral part of the corresponding electrode 3, 5 or forms the electrode itself.

In such a polymer electrolyte membrane fuel cell (PEM fuel cell), fuel or fuel molecules, in particular hydrogen, are split into protons and electrons at the first electrode 3 (anode). The membrane 2 allows the protons (e.g., H⁺) to pass through, but is impermeable to the electrons (e). The membrane 2 is formed from an ionomer, such as a polytetrafluoroethylene polymer (PTFE) or a polymer of perfluorosulfonic acid (PFSA). The membrane 2 can alternatively be formed as a sulfonated hydrocarbon membrane. In this case, the following reaction occurs at the anode: 2H₂→4H⁺+4e⁻ (oxidation/electron release).

While the protons pass through the membrane 2 to the second electrode 5 (cathode), the electrons are conducted to the cathode or to an energy storage device via an external circuit. A cathode gas, in particular oxygen or oxygen-containing air, is provided at the cathode, so that the following reaction takes place there: O₂+4H⁺+4e⁻→2H₂O (reduction/electron capture).

A first gas diffusion layer 7 is assigned to the first electrode 3 and a second gas diffusion layer 8 is assigned to the second electrode 5. The gas diffusion layers may be made of carbon fiber paper (CFP). Standard dimensions keep the manufacturing complexity for the individual components of the fuel cell assembly 1 as limited as possible. For this reason, the membrane 2 has a (cross-sectional) surface area in lateral extension which corresponds to that of the electrodes 3, 5.

To improve a fluid or gas flow within the fuel cell assembly and to increase a water content in the membrane, a first microporous layer 20 is assigned to the first gas diffusion layer 7 on its side facing the first electrode 3. Likewise, a second microporous layer 21 is assigned to the second gas diffusion layer 8 on its side facing the second electrode 5. The lateral dimensions of the microporous layers 20, 21 correspond substantially to the lateral dimensions of the respective gas diffusion layers 7, 8.

To increase the stability of the fuel cell assembly, a frame 11 with a recess 12 is arranged between the first electrode 3 and the first gas diffusion layer 7. An active area 14 of the membrane electrode arrangement 1 can be predefined by a flow cross section 13 defined by the recess 12.

At the same time, the flow cross section 13 of the recess 12 has a smaller surface area than the surface area of a flow cross section 15 of the second gas diffusion layer 8. The flow cross section 33 of the first gas diffusion layer 7 substantially corresponds to the flow cross section 15 of the cross section of the second gas diffusion layer 8 oriented orthogonally to the stacking direction.

The membrane electrode assembly 1 has an edge area 9 on the outer circumference side. The edge area 9 of the membrane electrode assembly 1 is understood to be an area of the membrane electrode assembly 1 surrounding the outer circumference side of the membrane electrode assembly 1 and extending parallel and in part orthogonally to the stacking direction.

An adhesive layer 10 is provided for a firm bonding of the frame 11 to the membrane electrode assembly 1. The adhesive layer 10 bonds the frame 11 directly to the membrane 2 of the membrane electrode assembly. In this, the first electrode 3 is completely penetrated by material of the adhesive layer 10, for which it may have a suitable porosity. In the same way, the membrane 2 of the membrane electrode assembly 1 can also be directly bonded in the edge area 9 to the second gas diffusion layer 8 by the adhesive layer 10, wherein the second electrode 5 is here also provided with suitable porosity and is completely penetrated by material of the adhesive layer 10.

The adhesive layer 10 herein laterally surrounds the membrane of the membrane electrode arrangement 1 in the edge area 9, which is to say on the outer circumference side; in particular, in a complete manner. The adhesive layer 10 thereby has a U-shaped or C-shaped cross section and is formed from a first adhesive layer section 16 and a second adhesive layer section 17. The first adhesive layer section 16 bonds—through the first electrode 3—the membrane 2 in an edge area 9 of the membrane electrode arrangement 1 to an inner edge area 18 of the frame 11 near the recess 12. The inner edge area 18 of the frame 11 is thereby formed as a partial area of the frame 11 extending outward on the inner circumference side. The second adhesive layer section 17 bonds the second gas diffusion layer 8—through the second electrode 5—to the membrane 2 in the edge area 9 of the membrane electrode assembly 1. Beyond this, a second adhesive layer 19 is provided which bonds the inner edge area 18 of the frame 11 to the first gas diffusion layer 7. During assembly of the fuel cell assembly, the two adhesive layer sections 16 and 17 coalesce to form a common adhesive layer 10 with a monolithic structure.

A first bipolar plate 27 which is attached to or assigned to the first gas diffusion layer 7 and provides an anode gas flow field 28 is provided on the anode side for the supply of fuel to the first electrode 3. Furthermore, a second bipolar plate 29 for supplying the cathode gas is assigned to the second gas diffusion layer 8 on the cathode side and has a cathode gas flow field 30. The cathode gas is fed through the second gas diffusion layer 8 to the second electrode 5 by the cathode gas flow field 30.

The lateral extension, which is to say, the extension perpendicular to the stacking direction, of the bipolar plates 27, 28 is greater than that of the gas diffusion layers 7, 8 and corresponds substantially to that of the frame 11. A first sealing layer 22 is arranged between a first frame side 23 of the frame 11 and the first bipolar plate 27 and seals the first gas diffusion layer 7 on the circumference side. A second sealing layer 24 is provided between a second frame side 25 of the frame and the second bipolar plate 28. The sealing layers 22, 24 are formed as compressible sealing lips, each of which is provided multiple times laterally. In the present embodiment example, three sealing lips are provided laterally in each case, which sealing lips are arranged on the circumference side around the first gas diffusion layer 7 and the second gas diffusion layer 8. Thus, the first sealing layer 22 and the second sealing layer 24 each have a total of six of the sealing lips. Another number is possible. In this, the sealing lips of the first sealing layer 22 have a larger diameter than the sealing lips of the second sealing layer 26.

Beyond this, a first channel 31 and a second channel 32, both extending in the stacking direction through the first bipolar plate 27, the second bipolar plate 29 and the frame 11, are provided laterally to the membrane electrode assembly 1, first channel 31 for supplying the fuel, second channel 32 for supplying the cathode gas to the fuel cell assembly. The channels 31, 32 are arranged within the fuel cell assembly in such a way that, on the side facing the gas diffusion layers 7, 8, in each case two sealing lips of the first sealing layer 22 and in each case two sealing lips of the second sealing layer 24 are arranged inside and, on the side opposite thereto, in each case one sealing lip of the first sealing layer 22 and one sealing lip of the second sealing layer 24 are arranged outside.

On the basis of the penetration of the electrodes 3, 5 with the material of the adhesive layer 10, a suitable pairing of contact partners results, since both the membrane 2 and the adhesive layer 10 are made of a polymer, which leads to an improved adhesive bond. Since the frame 11 can also be formed of a polymer, such an enhanced adhesive effect is also seen at the contact surface of the frame 11 with the adhesive layer 10. This leads overall to an even more stable fuel cell assembly, which at the same time exhibits improved sealing.

Aspects of the various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A fuel cell assembly, comprising:
a membrane electrode assembly including:
a membrane;
a first electrode arranged on a first side of the membrane and to which a first gas diffusion layer is assigned; and
a second electrode arranged on a second side of the membrane opposite to the first side of the membrane and to which a second gas diffusion layer is assigned;
a frame; and
an adhesive layer directly bonding the membrane electrode assembly to the frame, wherein the adhesive layer is present at least in certain areas at an edge area of the membrane electrode assembly, wherein the adhesive layer penetrates the first electrode, and wherein the membrane is directly bonded to the frame as a result of the penetration, and
wherein the adhesive layer has a first adhesive layer section connecting the membrane at the edge area to the frame and a second adhesive layer section connecting the membrane at the edge area to the second gas diffusion layer.

2. The fuel cell assembly of claim 1, wherein the first electrode has a porosity configured such that the adhesive layer fully penetrates the first electrode to bond the frame to the membrane.

3. The fuel cell assembly according to claim 1, wherein the adhesive layer has a viscosity selected to completely penetrate the first electrode to bond the frame to the membrane.

4. The fuel cell assembly according to claim 1, wherein the adhesive layer has a surface energy and/or surface tension selected so that the adhesive layer completely penetrates the first electrode to bond the frame to the membrane.

5. (canceled)

6. The fuel cell assembly according to claim 1, wherein the membrane and the electrodes are formed in lateral extension with an identical surface area.

7. The fuel cell assembly according to claim 6, wherein the frame comprises a recess with a flow cross section whose surface area is smaller than the lateral surface area of the membrane.

8. The fuel cell assembly according to claim 6, wherein a first sealing layer that circumferentially seals the first gas diffusion layer is assigned to the frame on a first frame side, and a second sealing layer that circumferentially seals both the second gas diffusion layer and the membrane is assigned to the frame on a second frame side that is opposite the first frame side.

9. A fuel cell system including a fuel cell assembly comprising:
a membrane electrode assembly including:
a membrane; and
a first electrode arranged on a first side of the membrane and to which a first gas diffusion layer is assigned;
a frame; and
an adhesive layer directly bonding the membrane electrode assembly to the frame, wherein the adhesive layer is present at least in certain areas at an edge area of the membrane electrode assembly, wherein the adhesive layer penetrates the first electrode, and wherein the membrane is directly bonded to the frame as a result of the penetration.

10. A fuel cell vehicle having a fuel cell system including a fuel cell assembly comprising:
a membrane electrode assembly including:
a membrane; and
a first electrode arranged on a first side of the membrane and to which a first gas diffusion layer is assigned;
a frame; and
an adhesive layer directly bonding the membrane electrode assembly to the frame, wherein the adhesive layer is present at least in certain areas at an edge area of the membrane electrode assembly, wherein the adhesive layer penetrates the first electrode, and wherein the membrane is directly bonded to the frame as a result of the penetration.
